(19) United States
(12) Patent Application Publication
(10) Pub. No.: US 2012/0187700 A1
(43) Pub. Date: Jul. 26, 2012

(54) ELECTROLYSIS CELL AND ELECTRICAL POWER UNIT INCORPORATING SAME

(75) Inventor: John Wayne Craft, Quinninup (AU)

(73) Assignee: Craft Holdings WA Pty Ltd., Quinninup, Western Australia (AU)

(21) Appl. No.: 13/388,238

(22) PCT Filed: Aug. 3, 2010
(86) PCT No.: PCT/AU2010/000977

§ 371 Date: Apr. 9, 2012

(30) Foreign Application Priority Data
Aug. 3, 2009 (AU) 2009903600

(51) Int. Cl. C25B 1/04; F23K 5/18; H02K 7/18; C25B 15/02

(52) U.S. Cl. 290/1 R; 204/229.4; 204/229.5; 204/218; 431/253

(57) ABSTRACT

Electrolysis cell (10) comprises a DC voltage source (12) with positive and negative terminals (14, 16) to alternating electrodes (18) and (20) respectively. The source (12) produces a voltage that cycles between a minimum voltage Vₘᵢₙ and a maximum voltage Vₘₐₓ where Vₘᵢₙ≧0 volts, and Vₘₐₓ=Vₘᵢₙ+Δ, where Δ>0 volts. Thus, the voltage provided by the DC source (12) is in the form of a periodic wave having a period T, and frequency f. As the voltage source (12) cycles its voltage from Vₘᵢₙ to Vₘₐₓ, there is an intermediate peak V_{P1} between Vₘᵢₙ and Vₘₐₓ. When the voltage reaches V_{P1}, it decreases for a period of time T_{P1}, before again ramping up to voltage Vₘₐₓ. The voltage then decreases relatively rapidly to Vₘᵢₙ, completing one cycle of period T.

### FIELD OF THE INVENTION

The present invention relates to an electrolysis cell and an electrical power unit incorporating the electrolysis cell.

### BACKGROUND OF THE INVENTION

Electrolysis is a well known process using direct current to drive a chemical reaction. In the electrolysis of water, a chemical reaction occurs in which liquid water is decomposed into hydrogen gas and oxygen gas by action of an electric current being passed through the water. The hydrogen can be used as a fuel for powering a machine or engine. For example hydrogen may be used for combustion in a combustion engine, or combusted to drive a boiler and turbine arrangement to produce electrical energy.

The efficiency of the electrolysis process is effected by many different parameters such as, but not limited to, the voltage and current applied to the cell; shape and configuration of electrodes used in the cell; the presence and/or type of electrolytes used; and, the ability to release gas bubbles from the electrodes.

### SUMMARY OF THE INVENTION

One aspect of the invention provides an electrolysis cell comprising:
a DC voltage source having a positive terminal and a negative terminal;
at least one electrode electrically connected to the positive electrode, and at least one electrode electrically connected to the negative electrode;
the DC voltage source capable of delivering a voltage that cycles at a period T between a minimum voltage Vₘᵢₙ≧0 volts and Vₘₐₓ=Vₘᵢₙ+Δ where Δ>0 volts, and wherein the voltage has at least one intermediate peak while ramping from Vₘᵢₙ to Vₘₐₓ.

In one embodiment the DC voltage source cycles at a frequency of between 300 and 2000 Hz.

In an alternate embodiment the DC voltage source cycles at a frequency of between 500 and 1500 Hz.

In a further embodiment the DC voltage source cycles at a frequency of between 900 and 1100 Hz.

In one embodiment the DC voltage source ramps from V_{min to} Vₘₐₓ in a time of 0.6 T to 0.9 T.

In an alternate embodiment the DC voltage source ramps from V_{min to} Vₘₐₓ in about ⅔ T.

In one embodiment Δ may be less than 1000 volts.

In the same or an alternate embodiment Δ is less than 500 volts.

In the same or an alternate embodiment Δ is less than 300 volts.

In the same or an alternate embodiment Δ is about 250 volts.

The DC source may be capable of an output of up 100 amps.

In one embodiment the DC source is capable of an output of up to 50 amps.

In an alternate embodiment the DC source is capable of an output of between 2 to 12 amps.

The electrodes connected to the positive terminal may be in the form of either (a) solid plates; or, (b) perforated plates or mesh; and, the electrodes connected to the negative terminal are in the form the other of (a) solid plates; or, (b) perforated plates or mesh.

The electrodes may be pivotally mounted to enable rotation of the electrodes while maintain electrical contact with their respective terminals.

In one embodiment the DC voltage source is arranged such that

0.05Δ≦V_{P1}≦0.2Δ.

In the same or an alternate embodiment the or each intermittent peak V_{P1} may have a period T_{P1} wherein 0.1 T≦T_{P1}≦0.4 T

A second aspect of the invention provides an electrical power unit comprising:
an electrolysis cell according to the first aspect of the invention;
a volume of water in the cell wherein the cell can produce hydrogen gas;
an energy conversion system capable of combusting the hydrogen gas and converting energy released by the combustion to electrical energy.

In the first or second aspects of the invention the DC voltage source may comprise a rechargeable battery and a wave shaping system coupled between the battery and the positive and negative terminals for producing the cycling DC voltage.

The electrical power unit may comprise a renewable energy transducer producing electricity from a renewable energy source and coupled with the rechargeable battery.

The energy conversion system may be coupled with the rechargeable battery.

The energy conversion system may comprise a heat exchanger for transferring heat from the combusting hydrogen gas to a liquid to convert the liquid to a vapour; and, an electric generator driven by the vapour to produce electricity.

The heat exchanger may comprise a burner for combusting the hydrogen, a tank holding a volume of the liquid, and a ceramic heat diffuser interposed between the burner and the tank.

The heat exchanger may comprise a condenser coupled in a sealed circuit with the tank wherein liquid heated in the tank changes phase to from a vapour which exits the tank and flows through the condenser to change phase back to a liquid and is returned to the tank.

The electrical power unit may comprise one or more turbines coupled with the electric generator and arranged to be driven by the vapour wherein the electric generator is driven by the vapour via the one or more turbines.

The one or more turbines may be coupled in the sealed circuit and interposed between the boiler and the condenser.

In an alternate embodiment of the electrical power unit the energy conversion system may comprise a combustion engine fuelled by the hydrogen gas; and, an electric generator driven by the engine produce electricity.

A third aspect of the invention provides a water heater comprising:
an electrolysis cell according to the first aspect of the invention; and,
a heat exchanger comprising a burner capable of combusting hydrogen produced by the electrolysis cell, and one or more pipe through which water is capable of flowing within a region heated by the combustion hydrogen wherein heat is transferred to the water flowing through the one or more pipe.

In one example with Δ in the order of about 250V and period T= 1/980 seconds, V_{P1}=150V; Vx=130 volts and T_{P1}=0.3 T thus V_{P1}−Vx=20=0.08Δ.

A fourth aspect of the invention provides a turbine comprising:
a shaft rotatable about a longitudinal axis of the shaft;
a first chamber provided with at least one rotor fixed to the shaft and capable of rotation with the shaft about the longitudinal axis by action of a flow of fluid into the first chamber;
a second chamber capable of supporting a negative pressure environment relative to the first chamber; and,
a valve system which is capable of controlling fluid flow between the first and second chambers.

The turbine may comprise an impeller disposed in the second chamber and fixed to the shaft, the impeller configured to generate the negative pressure environment when rotated with the shaft.

The valve system may comprises one or more fluid flow paths between the first and second chambers, and an actuator capable of progressively opening and constricting the fluid flow paths.

The actuator may be configured to respond to an input signal indicative of fluid pressure in the turbine.

The actuator may also be configured to respond to an input signal indicative of speed of rotation of the shaft.

The valve system may comprise first and second structures disposed between the first and second chambers, the first and second structures provided with first and second sets of holes respectively, wherein the first and second structures are movable relative to each other between the first position where the holes in the respective structures register, or at least partially overlap, with each other; and, a second position where the holes in the first and second structures are offset from each other.

The first and second members may comprise first and second plates which lie one upon the other and between the impeller and the at least one rotor.

The actuator may be coupled to one of the first and second structures and capable of moving one of the first and second structures relative to the other of the first and second structures.

A fifth aspect of the invention provide an electrical power unit comprising:
an electrolysis cell according to the first aspect of the invention;
a volume of water in the cell wherein the cell can produce hydrogen gas;
a heat exchanger capable of combusting the hydrogen gas and boiling a liquid to produce a vapour of the liquid;
one or more turbines according to the fourth aspect of the invention wherein the or each turbine is driven by a flow of the vapour; and,
an electric generator coupled with and driven by the or each turbine.

A sixth aspect of the invention provides an electrical power unit comprising:
an electrolysis cell capable of electrolysis of water to produce hydrogen gas;
a heat exchanger capable of combusting the hydrogen gas and boiling a liquid to produce a vapour of the liquid;
one or more turbines according to the fourth aspect of the invention wherein the or each turbine is driven by a flow of the vapour; and,
an electric generator coupled with and driven by the or each turbine.

### BRIEF DESCRIPTION OF THE DRAWINGS

Embodiments of the present invention will now be described by way of example only with reference to the accompanying drawings in which:

FIG. 1 is a schematic representation of an embodiment of an electrolysis cell in accordance with the present invention;

FIG. 2 is a representation of a driving voltage produced by a DC source of the cell;

FIG. 3 is a block diagram representation of an embodiment of an electrical power unit incorporating the electrolysis cell;

FIG. 4 is a further representation of an embodiment of electrolysis cell;

FIG. 5 is a schematic representation of a heat exchanger which may be incorporated in the electrical power unit shown in FIG. 3;

FIG. 6 is a representation of a further heat exchanger which may be incorporated in the electrical power unit;

FIG. 7 is a representation of a further form of heat exchanger which may be incorporated in the electrical power unit;

FIG. 8 is a representation of a water heater incorporating an embodiment of the electrolysis cell;

FIG. 9 is a section view of a turbine that may be incorporated in the electrical power unit;

FIG. 10 is a plan view of a valve system incorporated in the turbine; and,

FIG. 11 is a schematic representation of an embodiment of an electrical power unit and corresponding control system.

### DETAILED DESCRIPTION OF THE PREFERRED EMBODIMENTS

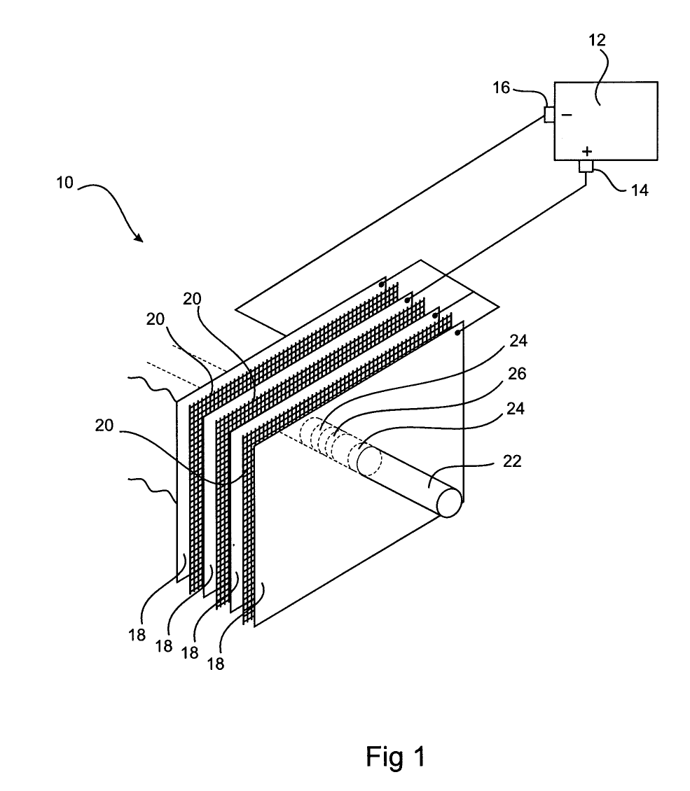

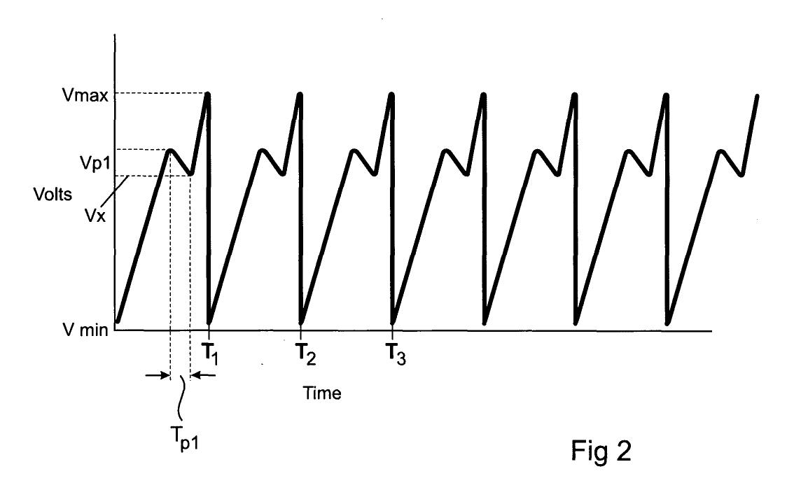

With reference to the accompanying drawings, and in particular FIGS. 1 and 2, an electrolysis cell 10 in accordance with an embodiment of the present invention comprises a DC voltage source 12 having a positive terminal 14 and a negative terminal 16. The positive terminal 14 is electrically coupled to a plurality of electrodes 18 while negative terminal 16 is electrically coupled to a plurality of electrodes 20. The electrodes 18 in this embodiment are in the form of plates and constitute positive electrodes or anodes of cell 10. Electrodes 20 are in the form of sheets of mesh or perforated plates and form negative electrodes or cathodes. When the electrodes 18 and 20 are immersed in water, and the DC voltage source 12 is coupled with the electrodes 18 and 20, a current flows through the water decomposing the water into hydrogen gas which forms at the negative electrodes 20, and gaseous oxygen which forms at the electrodes 18.

FIG. 2 illustrates the voltage delivered by the source 12. The voltage cycles between a minimum voltage Vₘᵢₙ and a maximum voltage Vₘₐₓ where Vₘᵢₙ≧0 volts, and Vₘₐₓ=Vₘᵢₙ+Δ, where Δ>0 volts. Thus, the voltage provided by the DC source 12 is in the form of a periodic wave having a period T, and frequency f. The voltage wave is applied at the positive terminal 14. When Vₘᵢₙ=0V the negative terminal 16 may be at ground or zero potential. As is evident from FIG. 2, as the voltage source 12 cycles its voltage from Vₘᵢₙ to Vₘₐₓ, there is an intermediate peak V_{P1} between Vₘᵢₙ and Vₘₐₓ. When the voltage reaches V_{P1}, it decreases for a period of time T_{P1}, before again ramping up to voltage Vₘₐₓ. The voltage then decreases relatively rapidly to Vₘᵢₙ, completing one cycle of period T.

The time taken for the voltage in any one cycle to ramp from Vₘᵢₙ to Vₘₐₓ in one embodiment may be in the order of 0.6 T to 0.9 T. In a further embodiment, the time for the DC voltage source to ramp from Vₘᵢₙ to Vₘₐₓ per cycle may be about ⅔ T.

The period T_{P1} in one embodiment is in the order of 0.1 to 0.4 T. The drop in voltage during this period may be in the order of 0.05Δ to 0.2Δ. That is, with reference to FIG. 2, if the voltage drops from the intermediate peak V_{P1} to a voltage V_{X} before ramping to the voltage Vₘₐₓ, then V_{P1}−V_{X} may be between 0.05Δ and 0.2Δ.

Although the theory is not well understood, it has been found that utilising the voltage source 12 with a DC voltage having a wave shape or form shown in FIG. 2 with at least one intermediate peak V_{P1} between minimum and maximum voltages Vₘᵢₙ and Vₘₐₓ assists in the production and release of hydrogen gas in the cell 10. In one test conducted on a cell 10 comprising six electrodes 18, 20 (i.e. three electrodes 18 and three electrodes 20) where the voltage source 12 provided an electrical input for the cell 10 of 4 amps at 250V with a frequency of 950 Hz, 1 m³ of hydrogen gas was produced per hour. In another test conducted, where the cell 13 comprises thirteen electrodes (seven electrodes 18 and six electrodes 20) and the source 12 was arranged to provide an electrical input of 11 amps at 250V with a frequency of 950 Hz, 2.5 m³ of hydrogen was produced per hour.

In one embodiment the DC source 12 is arranged to cycle at a frequency f of 300 to 2000 Hz. However in an alternate embodiment, the frequency may be between 500 and 1500 Hz. In yet a further embodiment, the frequency may be between 900 and 1100 Hz. The difference between Vₘᵢₙ and Vₘₐₓ, i.e. Δ in one embodiment may be less than 1000 volts. In a further embodiment Δ may be less than 500 volts. In a further embodiment Δ may be less than 300 volts. In yet a further embodiment Δ may be in the order of 250 volts.

In one embodiment the DC source 12 is able to deliver a current of up to 100 amps. However in an alternate embodiment the DC source is capable of producing or delivering an output of up to 50 amps. In yet a further embodiment, the DC source 12 may be capable of producing or delivering an output of between 2 to 12 amps.

The shape of the voltage signal or wave depicted in FIG. 2 may be produced by known wave shaping systems including use of modulated rectifiers, or by appropriate driving of servo motors to produce the required voltage output.

It has further been discovered that production of hydrogen gas may be increased by rotating the electrodes 18, 20 through the water. It is believed that this action assists in releasing gas bubbles which may otherwise adhere to the electrodes and interrupt current flow thereby reducing gas production. To facilitate the rotation of electrodes 18, 20, the electrodes may be mounted on a shaft 22 provided with a plurality of slip rings 24 and 26 to maintain electrical connection between the electrodes 18 and 20 and respective terminals 14 and 16. This rotation may be effected by way of a conventional electric motor.

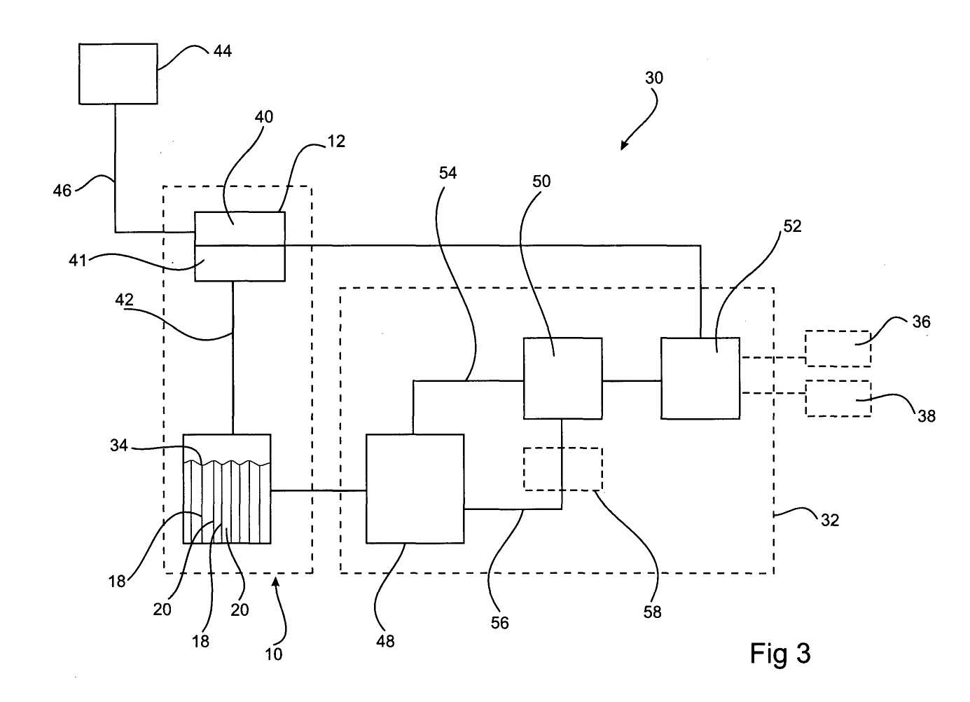

FIG. 3 depicts in a block diagram form, an electrical power unit 30 comprising or driven by the electrolysis cell 10. The electrical power unit 30 comprises an energy conversion system 32 which is capable of combusting hydrogen gas produced by the cell 10 and converting energy released by the combustion to electrical energy. To produce hydrogen gas, a volume of water 36 is contained or held in the cell 10. Electrical energy produced by system 32 can be coupled to: a base load 36, which for example may comprise electrical appliances and devices in a house; a grid 38; and the DC source 12. The DC source 12 comprises a rechargeable battery 40 and a wave shaping system 41 to produce the voltage wave shape shown in FIG. 2. Cables 42 connect DC source 12 to electrodes 18 and 20 of cell 10. A power management unit (not shown) is provided to control flow of electricity from the system 32 to base load 36, grid 38 and rechargeable battery 40. Electrical power unit 30 further comprises a renewable energy transducer 44 which produces electricity and delivers the electricity via conductors 46 to the rechargeable battery 40. The renewable energy transducer 44 may be in the form of, for example, a photovoltaic cell, or a wind turbine, or both.

In the present embodiment, energy conversion system 32 comprises a heat exchanger 48, turbine 50, and an A.C. generator 52. Heat exchanger 48 burns or combusts hydrogen produced by cell 10 to convert liquid water in the heat exchanger to water vapour, i.e. steam which in turn drives turbine 50. Turbine 50 drives A.C. generator 52 to produce electricity. The steam passing through turbine 50 is condensed to a liquid and returned to the heat exchanger 48 in a closed or sealed circuit comprising conduits 54 and 56. A condenser 58 may be placed in the sealed circuit between turbine 50 and the heat exchanger 48 to assist in condensing the steam back to a liquid prior to returning to heat exchanger 48.

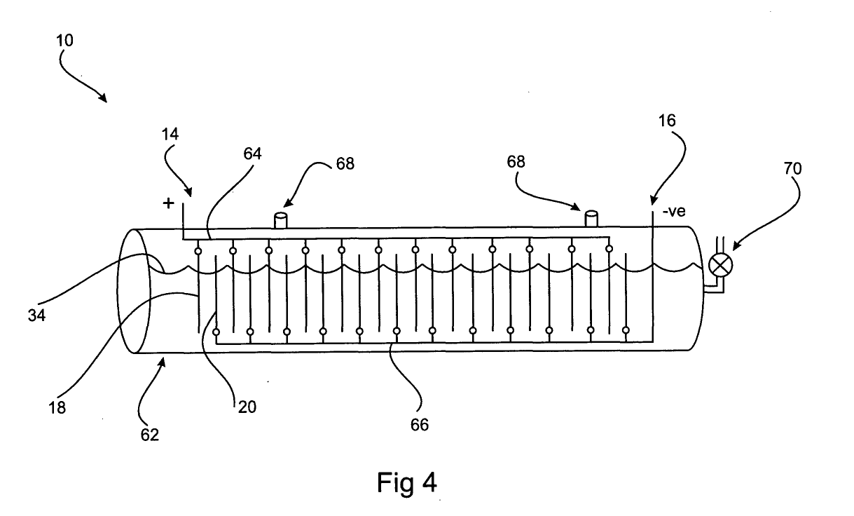

FIG. 4 illustrates in further detail components of the cell 10. The cell 10 comprises a casing 62 for holding the volume of water 34 and in which is disposed electrodes 18 and 20. Casing 62 may be made of metal or alternately from a non-electrically conducting material such as a carbon fibre composite, or an olefin. In the event that casing 62 is made from a metal, the casing may be polarised to eliminate cathodic and anodic reactions. Alternately, when made from metal, an interior surface of casing 62 may be lined with a non-conductive material. A bus or rail 64 connects electrodes 18 together and in turn is coupled with positive terminal 14. A separate bus or rail 66 connects the electrodes 20 together and is coupled with negative terminal 16. Casing 62 is provided with two gas outlets 68 for directing hydrogen and oxygen gas produced by electrolysis to the heat exchanger 48. Casing 62 is also plumbed to a water supply (not shown) via valve 70 to maintain a predetermined level of water 34 within cell 10. Valve 70 may for example be in the form of a simple ball valve. Alternately, other water level sensing systems may be incorporated in casing 62 to control valve 70 to maintain a level of water 34 within a predetermined range within casing 62.

In the present embodiment, both hydrogen and oxygen gas produced by electrolysis are channelled together to the heat exchanger 48 and combusted together. Although in an alternate embodiment, the hydrogen and oxygen gasses may be separately collected with the hydrogen being directed to heat exchanger 48, and oxygen either being discharged or collected for other purposes.

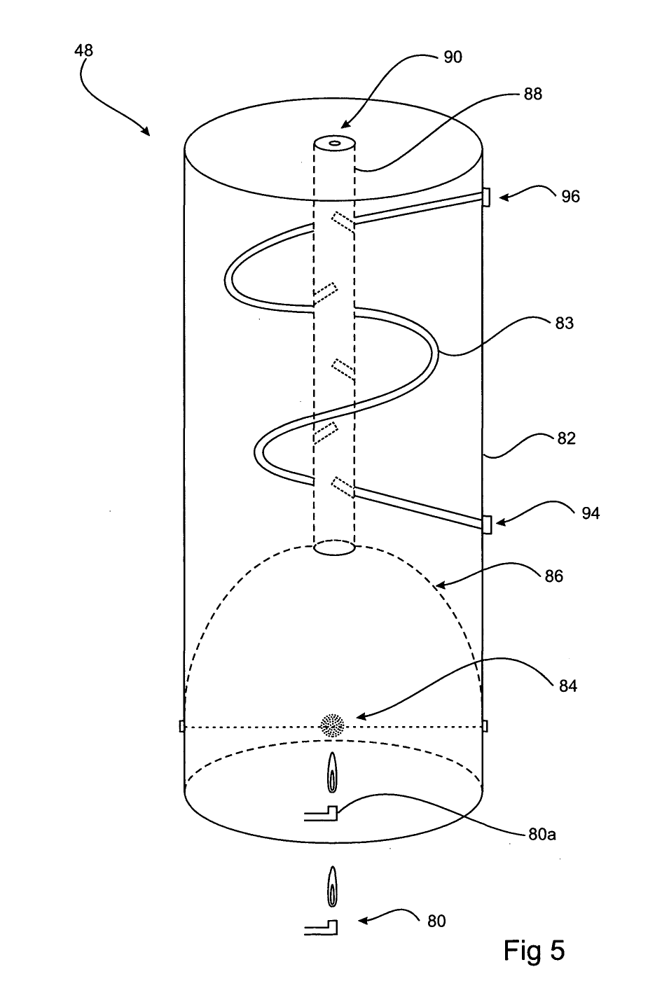

FIG. 5 illustrates one possible configuration of heat exchanger 48. In this embodiment, heat exchanger 48 is in the form of a boiler comprising single flame burner 80 for burning or combusting the hydrogen gas produced by cell 10; tank 82 containing heat exchange elements including a conduit 83 carrying a liquid that when heated by the burning hydrogen changes phase to a vapour; and, a ceramic heat diffuser 84 interposed between burner 80 and tank 82 to assist in dispersing heat generated by the burning hydrogen more evenly and, protecting tank 82 from being damaged by the burning hydrogen. The diffuser 84 may be in the shape of a flat disc, or may have a shallow disc like shape.

Burner 80 may be arranged in a manner where the distance between the burner 80 and a base 86 of tank 82 can be varied. This is shown by single flame burner 80a depicted in phantom line. In this embodiment, base 86 is domed so as to be generally concave in shape when viewed from outside of tank 82 to assist in collected and equalising heat distribution over base 86. Tank 82 is formed with a axially extending conduit 88 provided with a controllable vent 90 at an upper most end. Vents 90 can be progressively opened or closed to control heat flow through heat exchanger 48. The plurality of baffles 92 are provided in the conduit 88 to further assist in heat capture. Conduit 92 is round about conduit 88 and forms part of the sealed circuit which includes conduits 54 and 56 shown in FIG. 3. Conduit 83 has an inlet 94 and outlet 96. Water flows into inlet 94 and is heated by energy released from the burning hydrogen to produce steam which exits from outlet 96. The steam 96 then flows through conduit 54 to drive turbine 50. The steam expands through turbine 50 which is converted to kinetic energy driving an output shaft which in turn drives A.C. generator 52. The steam expands by passing through turbine 50 thus decreasing in temperature and pressure. The reduction in temperature and pressure may be sufficient to produce condensate at an outlet of turbine 50 which flows together with any remaining vapour through conduit 56 back to inlet 94. Condenser 58 condenses any remaining steam to liquid water. As heat exchanger 48, turbine 50 and condenser 58 (when incorporated) form a closed or sealed circuit, there is no net consumption of liquid through the circuit.

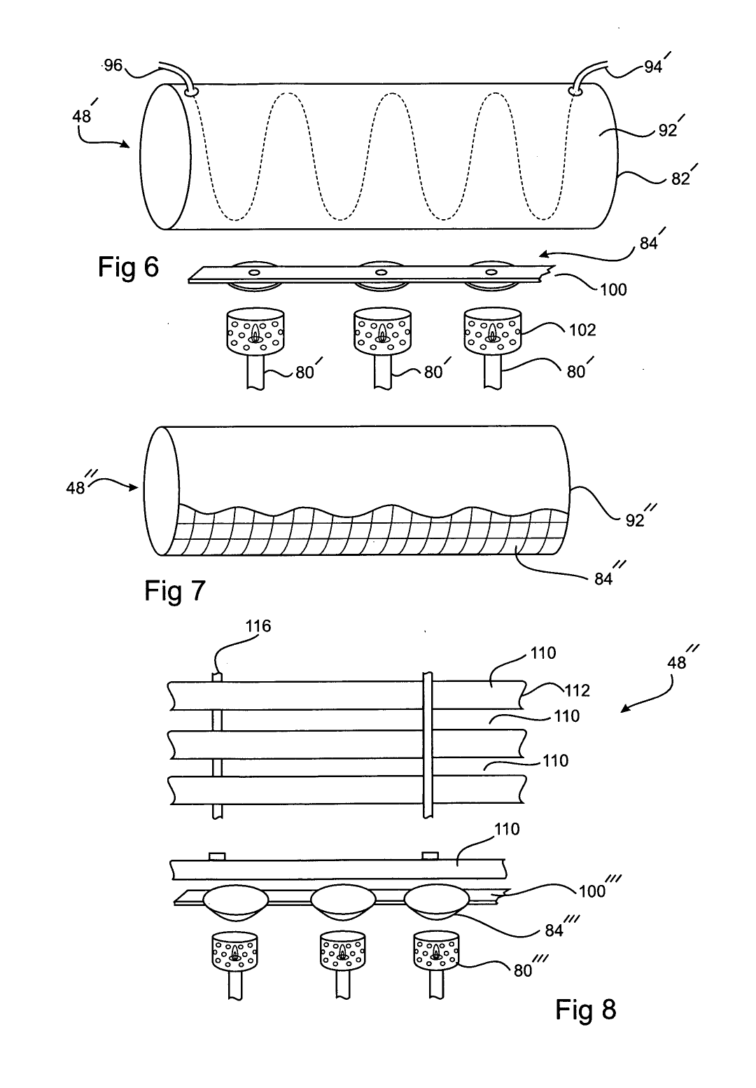

FIG. 6 illustrates an alternate form of heat exchanger 48′ which may be incorporated in the electrical power unit 30. Heat exchanger 48′ comprises a cylindrical tank 82′ which is orientated so that its axis lies horizontally rather than vertically as in the tank 82 shown in FIG. 5. Tank 82 is provided with an internal conduit 92′ through which a working fluid such as water can flow from inlet 94′ to outlet 96′ changing phase to form steam which in turn flows through to turbine 50. Due to its orientation, heat exchanger 48′ does not comprise a central conduit 88 and vent 90 shown in FIG. 5. However heat exchanger 48 comprises a plurality of burners 80′ disposed along a length of tank 82′. A ceramic diffuser 84′ is located above each burner 80′. The diffusers 84′ are mounted on a common support beam 100 and assist in more evenly spreading heat produced by burners 80′ to the working liquid contained or flowing through conduit 92′. Further, in the heat exchanger 48′, each burner 80′ is provided with a burner cup 102 which assists in containing the flame produced by the combusting hydrogen. Each burner cup 102 may be formed from a ceramic material or zirconium and is provided with a plurality of holes to assist in heat convection, as well as a open mouth or top 104 which is directed to a corresponding ceramic diffuser 84′.

FIG. 7 depicts yet a further form of heat exchanger 48″ which differs from heat exchanger 48′ by replacement of ceramic diffusers 84′ mounted on support beam 100 with ceramic diffusers 84″ bonded directly onto an outer surface of tank 92″.

FIG. 8 depicts an application of electrolysis cell 10 as a water heater. This may be used for example as a domestic or commercial/industrial water heater. Here, the cell produces hydrogen and oxygen which is burnt in heat exchanger 48′″ which comprises three burners 82′″ each provided with a corresponding diffuser 84′″ supported on beam 100′″. The heat exchanger 48′″ comprises a plurality of tubes or pipes 110 which are connected to an inlet manifold (not shown) at one end 112, and an outlet manifold (not shown) at end 114 to supply heated water. Pipes 110 are connected together by members 116. In one application the heat exchanger 48′″ can be plumbed to operate as an instant hot water system. Of course, the heat exchanger 48′″ can be adapted to provide water vapour (i.e. steam) as an output by simply controlling the flow rate of water through the heat exchanger 48′″ and the heat produced by the burners 80′″. In such an adaptation the heat exchanger 48′″ can be used in the electrical power unit 30 in place of heat exchangers 48, 48′ and 48″.

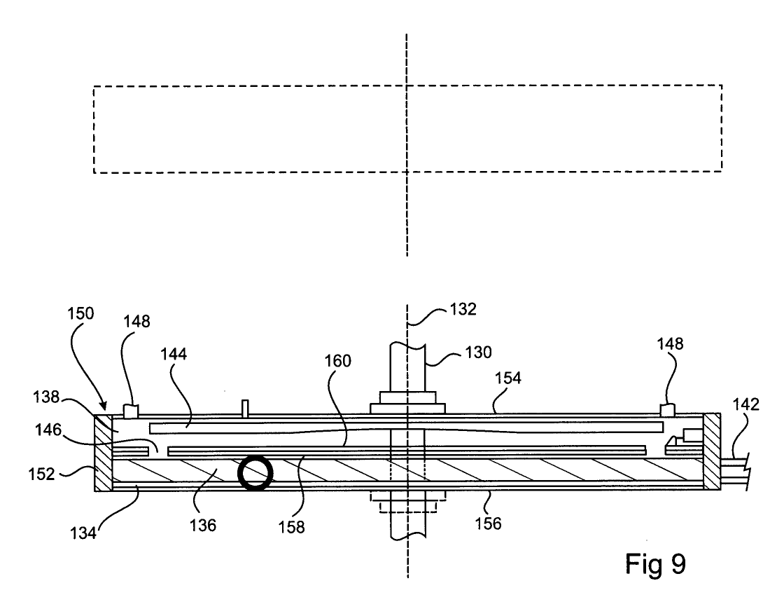

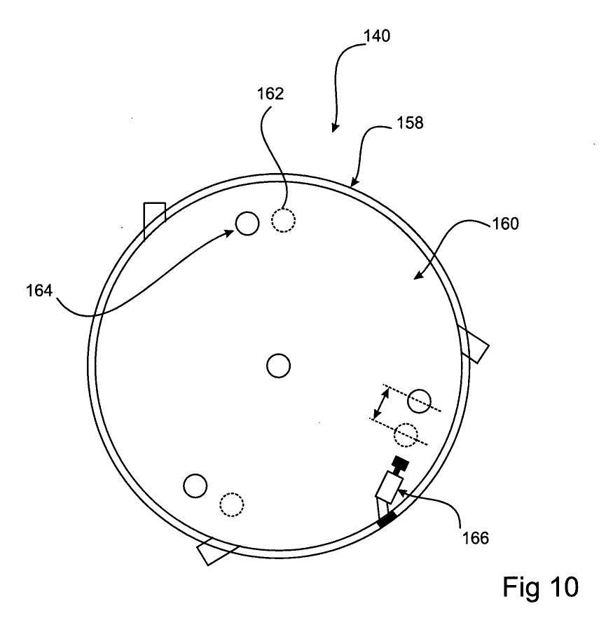

FIGS. 9 and 10 depict one possible form of turbine 50 which can be incorporated in the electrical power unit 30. In broad terms, turbine 50 comprises a shaft 130 which is rotatable about its longitudinal axis 132; a first chamber 134 provided with one or more (in this particular embodiment only one) rotor 136, a second chamber 138, and a valve system 140. Rotor 136 is fixed to and rotatable with the shaft 130. Steam produced by heat exchanger 48 is used as the working fluid and provided to the first chamber 134 via a plurality of inlets 142. The flow of steam into the first chamber 134 causes rotation of the rotor 136 and thus the shaft 130. The second chamber 138 is capable of supporting a negative pressure environment relative to the first chamber 134. In this embodiment, an impeller 144 is disposed in second chamber 138 and fixed to shaft 130. When shaft 130 is rotated by action of a flow of steam into the first chamber 134, impeller 144 rotates creating a relative negative pressure (i.e. vacuum) in chamber 138. A plurality of fluid flow paths 146 is provided between the first and second chambers 134 and 138 through which the steam used to drive rotor 134 can flow into chamber 138 and subsequently can be exhausted via exhaust ports 148. As described in greater detail below, valve system 140 is capable of progressively opening and constricting the fluid flow paths 146 to control the flow of steam from first chamber 134 to second chamber 138.

The turbine 50 also comprises an outer casing or housing 150 which contains first and second chambers 134, and 138 and through which shaft 130 passes. Casing 150 is formed by an annular ring or circumferential wall 152 and a pair of parallel circular outer plates 154 and 156 bolted to opposite axial ends of the ring 152.

Valve system 140 comprises first and second structures in the form of plates 158 and 160 which are disposed between rotor 136 and impeller 144. Indeed plates 158 and 160 lie one on top of the other within casing 150, dividing the casing 150 into the first and second chambers 134 and 138. Plate 158 is provided with a first set of holes 162 while plate 160 is provided with a second set of holes 164. Plate 158 is fixed relative to casing 150, while plate 160 can move and in particular rotate relative to plate 158. Moreover, plates 158 and 160 can be moved relative to each other between a first position where their respective holes 162 and 164 register, or at least partially overlap with each other as shown in FIG. 8 and a second position where the holes 162 and 164 are offset from each other as shown in FIG. 9. Fluid flow paths 146 are created by the holes 162 and 164. Thus these paths can be progressively opened and constricted by the relative motion of plates 158 and 160. This motion is affected by an actuator 166 in the form of a solenoid operated ram which is connected between casing 158 and plate 160. Extension and contraction of ram 166 causes plate 160 to rotate relative to the plate 158 to vary the degree of overlap or offset between holes 162 and 164 thereby opening or constricting flow paths 146. Actuator 166 is arranged to be responsive to input signals indicative of fluid pressure within turbine 50 (ie within casing 150, or one or both of first and second chambers 134, 138); and, rotational speed of shaft 130.

Steam produced by heat exchanger 48 flows into first chamber 134 via inlets 142 causing rotation of rotor 134 and subsequently, rotation of shaft 130 and impeller 144. In this particular embodiment, three inlets 142 are provided each of which directs steam substantially tangentially into chamber 134. The steam exits chamber 134 via flow paths 146 subsequently flowing into second chamber 138 to be exhausted via exhaust ports 148 and subsequently channelled back to heat exchanger 48 via conduit 56 and condenser 58. The relative negative pressure produced in chamber 138 by impeller 144 assists in drawing the steam through the turbine 50 as well as condensing the steam back to water. Turbine speed can be controlled by varying the flow of steam through flow paths 146 by automation of actuator 166 to vary the degree of overlap of holes 162 and 164.

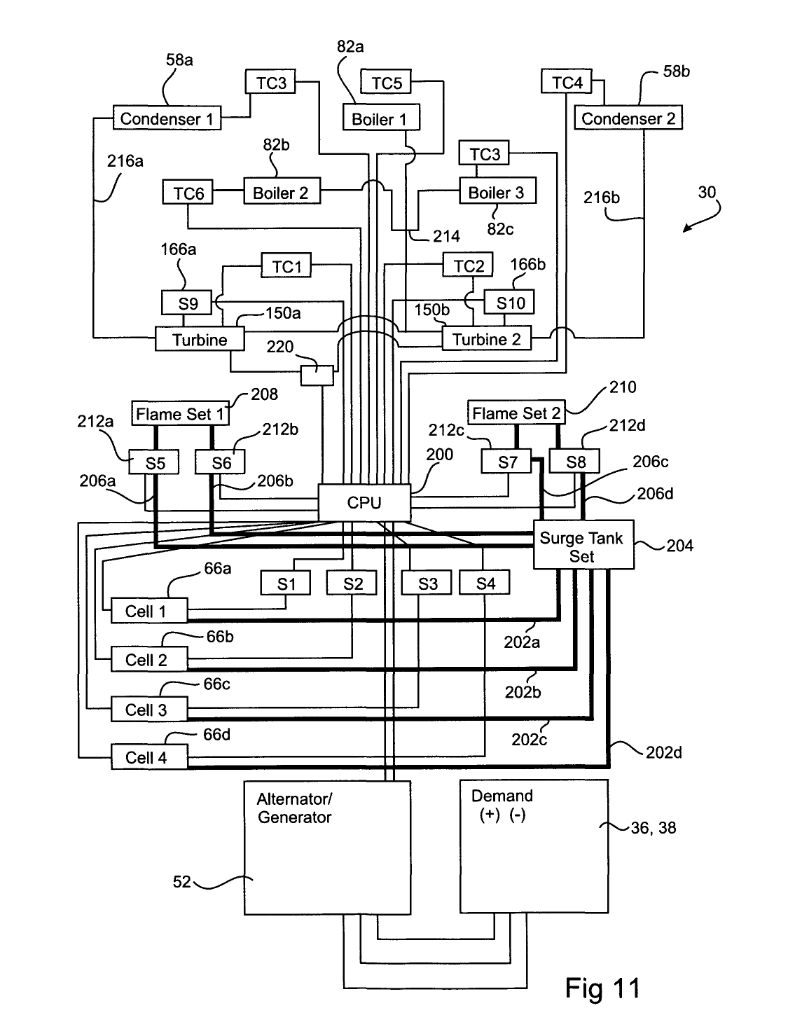

FIG. 11 illustrates an embodiment of the electrical power unit 30′ depicting in particular connections between various components of the unit 30 and a central controller 200 which may be in the form of a central processing unit, or a programmable logic controller (PLC). The electrical power unit 30′ comprises four electrolysis cells similar to cell 10 depicted in FIG. 3. However in FIG. 11, the DC supply voltage for each cell is embodied in the controller 200 and corresponding casings 66a, 66b, 66c and 66d (referred to in general as “casings 66”) are represented coupled with the controller 200 via corresponding switches s1, s2, s3 and s4. Thus, each casing 66 comprises electrodes 18 and 20 of an associated cell. The switches s1, s2, s3 and s4 operate to allow appropriate driving current from the controller 200 to the associated electrodes of that cell. Each of casing 66a, 66b, 66c and 66d is also coupled via conduits 202a, 202b, 202c and 202d to a surge tank 204. Thus the surge tank 204 stores hydrogen and oxygen gas provided by the electrolysis cells. This gas is fed via conduits 206a, 206b, 206c and 206d (referred to in general as “conduits 206”) to flame sets or combustors 208 and 210. However valves 212a, 212b, 212c and 212d are interposed between the conduits 206 and the respective flame sets 208 and 210. These valves are controlled by signals from the controller 200 to control the flow of gas to the flame sets 208 and 210. The flame sets 208 and 210 comprise burners similar to burners 80 described herein above. In a slight variation to the previously described embodiments where one or more burners were associated with a corresponding boiler, in the electrical power unit 30′, flame sets 208 and 210 provide heat to a common heat box which in turn supplies heat to three boilers 82a, 82b and 82c. Boilers 82a, 82b and 82c produce steam which is channelled via manifold 214 to each of turbines 150a and 150b. The turbines 150a and 150b drive A.C. generator 52 via a mechanical transmission system (not shown). Spent working fluid, i.e. steam from turbines 150a and 150b is channelled via corresponding conduits 216a and 216b to condensers 58a and 58b. Actuators 166a and 166b of turbines 150a and 150b respectively are coupled with the controller 200 to enable control of exhaust vapours from the turbines to the respective condensers.

The electrical power unit 30′ also comprises a plurality of thermocouples TC1-TC7 which are used to measure temperature and enable subsequent control by the controller 200 of associated devices or subsystems in the unit 30′. Specifically, thermocouple TC1 is associated with turbine 105a and provides temperature readings of the turbine 50a to the controller 200 to then enable subsequent control of actuator 166a. Similarly, thermocouple TC2 is associated with turbine 150b to provide turbine temperature to controller 200 to allow subsequent control of actuator 166b. Thermocouple TC3 and thermocouple TC4 are associated with condensers 50a and 50b respectively. These thermocouples provide an indication of temperature of steam exhausted from turbines to the corresponding condensers and relatively used as inputs to control actuators 166a and 166b. Thermocouples TCS, TC6 and TC7 are associated with corresponding boilers 82a, 82b and 82c respectively. These thermocouples provide temperature signals to the controller 200 to allow the controller 200 to regulate operation of the corresponding boilers. An actuator 220 is associated with both turbines 150a, 150b and controller 200. The actuator 220 operates to regulate both turbines in accordance with the demand or load on the generator 82. If the demand is sensed as being below a threshold, the actuator 220 is operated by controller 200 to shut down one turbine and may also control valves 212a-212d to modify heat generation to drive a single turbine. In this regard, greater efficiencies are obtain in a low demand situation by driving one turbine at a high speed rather than two turbines at lower speed. The controller 200 is also able to appropriately control the electrolysis cells, flame sets 208, 210 and turbines 150a and 150b in a manner to allow the most efficient generation of electricity via generator 52 dependent on those conditions.

Now that embodiments of the invention have been described in detail, it will be apparent to those skilled in the relevant arts that numerous modifications and variations may be made without departing from the basic inventive concepts. For example, energy conversion system 32 is described as comprising a heat exchanger 48, and turbine 50 which drives A.C. generator 52. However in one variation heat exchanger 48 and turbine 50 may be replaced by a combustion engine which combusts or burns the hydrogen to turn a drive shaft and/or flywheel in turn coupled to A.C. generator 52. Further, A.C. generator 52 may be replaced by a D.C. generator. In that event, if A.C. power is required, an inverter will be needed to convert D.C. to A.C. Further, the D.C. source 12 may be arranged to produce more than one intermittent voltage peak as voltage ramps from Vₘᵢₙ and Vₘₐₓ per cycle of the D.C. wave shown in FIG. 2. Also when the energy conversion system comprises a heat exchanger and a turbine, a working fluid other than water can be used.

All such modifications and variations are deemed to be within the scope of the present invention, the nature of which is to be determined from the above description and the appended claims.

1. An electrolysis cell comprising:
a DC voltage source having a positive terminal and a negative terminal;
at least one electrode electrically connected to the positive electrode, and at least one electrode electrically connected to the negative electrode;
the DC voltage source capable of delivering a voltage that cycles at a period T between a minimum voltage Vₘᵢₙ≧0 volts and Vₘₐₓ=Vₘᵢₙ+Δ where Δ>0 volts, and wherein the voltage has at least one intermediate peak Vp1 while ramping from Vₘᵢₙ to Vₘₐₓ.

2. The electrolysis cell according to claim 1 wherein the DC voltage source cycles at a frequency of between 300 and 2000 Hz.

3. (canceled)

4. The electrolysis cell according to claim 2 wherein the DC voltage source cycles at a frequency of between 900 and 1100 Hz.

5. The electrolysis cell according to claim 1 wherein the DC voltage source ramps from V_{min to} Vₘₐₓ in a time of 0.6 T to 0.9 T.

6. The electrolysis cell according to claim 5 wherein the DC voltage source ramps from V_{min to} Vₘₐₓ in about ⅔ T.

7. The electrolysis cell according to claim 1 wherein Δ is less than 1000 volts.

8.-9. (canceled)

10. The electrolysis cell according to claim 1 wherein Δ is about 250 volts.

11. The electrolysis cell according to claim 1 wherein the DC source is capable of an output of up to 100 amps.

12. (canceled)

13. The electrolysis cell according to claim 1 wherein the DC source is capable of an output of between 2 to 12 amps.

14. (canceled)

15. The electrolysis cell according to claim 1 wherein the electrodes are pivotally mounted to enable rotation of the electrodes while maintain electrical contact with their respective terminals.

16. The electrolysis cell according to claim 1 wherein:
0.05Δ≦V_{P1}≦0.2Δ.

17. The electrolysis cell according to claim 1 wherein the or each intermittent peak V_{P1} has a period T_{P1} wherein 0.1 T≦T_{P1}≦0.4 T.

18. An electrical power unit comprising:
an electrolysis cell according to claim 1;
a volume of water in the cell wherein the cell can produce hydrogen gas;
an energy conversion system capable of combusting the hydrogen gas and converting energy released by the combustion to electrical energy.

19. The electrical power unit according to claim 17 wherein the DC voltage source comprises a rechargeable battery and a wave shaping system coupled between the battery and the positive and negative terminals for producing the cycling voltage.

20.-21. (canceled)

22. The electrical power unit according to claim 17 wherein the energy conversion system comprises a heat exchanger for transferring heat from the combusting hydrogen gas to a liquid to convert the liquid to a vapour; and, an electric generator driven by the vapour to produce electricity.

23. The electrical power unit according to claim 19 wherein the heat exchanger comprises a burner for combusting the hydrogen, a tank holding a volume of the liquid, and a ceramic heat diffuser interposed between the burner and the tank.

24. The electrical power unit according to claim 19 wherein the heat exchanger comprises a condenser coupled in a sealed circuit with the tank wherein liquid heated in the tank changes phase to from a vapour which exits the tank and flows through the condenser to change phase back to a liquid and is returned to the tank.

25. The electrical power unit according to claim 23 comprising one or more turbines coupled with the electric generator and arranged to be driven by the vapour wherein the electric generator is driven by the vapour via the one or more turbines.

26. The electrical power unit according to claim 24 wherein the one or more turbines are coupled in the sealed circuit and interposed between the boiler and the condenser.

27. The electrical power unit according to claim 17 wherein the energy conversion system comprises combustion engine fuelled by the hydrogen gas; and, an electric generator driven by the engine to produce electricity.

28. (canceled)

29. The electrical power unit according to claim 24 wherein the or each turbine comprises:
a shaft rotatable about a longitudinal axis of the shaft;
a first chamber provided with at least one rotor fixed to the shaft and capable of rotation with the shaft about the longitudinal axis by action of a flow of fluid into the first chamber;
a second chamber capable of supporting a negative pressure environment relative to the first chamber; and
a valve system which is capable of controlling fluid flow between the first and second chambers.

30. The electrical power unit according to claim 27 comprising an impeller disposed in the second chamber and fixed to the shaft, the impeller configured to generate the negative pressure environment when rotated with the shaft.

31. The electrical power unit according to claim 29 27 wherein the valve system comprises one or more fluid flow paths between the first and second chambers, and an actuator capable of progressively opening and constricting the fluid flow paths.

32. The electrical power unit according to claim 29 wherein the actuator is configured to respond to an input signal indicative of fluid pressure in the turbine.

33. The electrical power unit according to claim 29 wherein the actuator is configured to respond to an input signal indicative of speed of rotation of the shaft.

34. The electrical power unit according to claim 27 wherein the valve system comprises first and second structures disposed between the first and second chambers, the first and second structures provided with first and second sets of holes respectively, wherein the first and second structures are movable relative to each other between the first position where the holes in the respective structures register, or at least partially overlap, with each other; and, a second position where the holes in the first and second structures are offset from each other.

35. The electrical power unit according to claim 33 wherein the first and second members comprise first and second plates which lie one upon the other and between the impeller and the at least one rotor.

36. The electrical power unit according to claim 33 wherein the actuator is coupled to one of the first and second structures and capable of moving one of the first and second structures relative to the other of the first and second structures.

37.-39. (canceled)
